(19) United States
(12) Patent Application Publication
(10) Pub. No.: US 2004/0236615 A1
(43) Pub. Date: Nov. 25, 2004

(54) Method and device for booking a parking space

(76) Inventor: Damien Msndy, Fontain (FR)

Correspondence Address: Joseph Sofer, Sofer & Haroun, Suite 910, 317 Madison Avenue, New York, NY, 10017, US

(21) Appl. No.: 10/479,394

(22) PCT Filed: May 27, 2002
(86) PCT No.: PCT/FR02/01765

(30) Foreign Application Priority Data
May 31, 2001 (FR) 01/07205

(51) Int. Cl. G06F 17/60

(52) U.S. Cl. 705/5

(57) ABSTRACT

A method of reserving a plurality of pay parking spaces supervised by at least one terminal (BO) of the parking meter type, including indicator means for each supervised space for indicating the state of payment (Si) defining whether or not parking is authorized, the method being characterized in that it comprises the following steps: a) a user (1) defining a reservation request (2) in accordance with selected parameters; b) the user receiving in return reservation data and the identity of at least one available parking space corresponding to said selected parameters; c) at the appropriate time, the user presenting said reservation data to the parking terminal (BO) associated with said parking space; and d) the terminal (BO) verifying said data and using said indicator means to indicate corresponding authorization to park.

The present invention relates to reserving a parking space.

Motor vehicle parking is raising ever increasing problems because of the increasing numbers of vehicles. The number of roadside spaces where vehicles can park is generally limited, particularly in town centers. In order to enable as large a number of people as possible to park in the most sought-after zones, local authorities have set up pay parking schemes.

In order to park a vehicle in a pay parking zone, a motorist must pay a sum of money corresponding to a selected parking duration, which duration is generally limited to a maximum of one or two hours. In the absence of such payment, the vehicle is parked illegally and can be booked or fined by suitably authorized parking wardens, or it can be sent to the car pound.

In order to park in pay parking spaces, the user generally pays a parking fee to a terminal provided for this purpose and located on the sidewalk close to the occupied parking space, which terminal is referred to below as a parking terminal.

Various kinds of parking terminal exist, mainly of the parking meter type or of the time-stamp meter type. The present invention relates more particularly to parking meters.

A parking meter type system comprises a terminal supervising a predetermined number of parking sites, and a motorist seeking to park is required to pay (by coins, card, etc.) an amount that corresponds to a desired parking time. The current state of payment defining the authorized or not authorizing status of parking is recorded for each site. This “paid” or “not paid” state is displayed by appropriate visual indicator means on the terminal, or else is issued in the form of a printed receipt, or indeed is transmitted to a hand-held inspection terminal carried by parking wardens.

Such a pay parking system is simple to monitor insofar as it suffices for parking wardens to ascertain the status of a site, either by the visual indication displayed on the corresponding terminal or by using the other means mentioned above in order to determine whether or not a vehicle occupying the site is parked legally.

Furthermore, in order to facilitate management of payment terminals by the operator (local authority, etc.), the Applicant has devised communicating parking terminals, i.e. terminals suitable for dialoguing with a remote central computer.

The remote central computer constitutes a management server enabling the operator of a set of payment terminals to supervise the operation of said terminals. In particular, the function of the server is to download parameter files, charging tables, or indeed updates for the programs causing the microprocessors of the payment terminals to operate, which updates improve the programs already in place or else provide new services for users.

In return, the terminals send daily activity reports or indeed alarms whenever events occur that require intervention of maintenance personnel: money box full, and also breakdowns or acts of vandalism.

Furthermore, car traffic in cities is presently a major concern of transport companies, local authorities, parking space operators, . . . .

One of the reasons why cities become congested with cars lies in finding parking spaces. For example, it is not uncommon for vehicles to drive around for many minutes in one particular part of town looking out for a parking site to become available.

In order to remedy that drawback, proposals have been made to fit parking spaces with sensors for sensing the presence of a vehicle and connected to a center. The center operates in real time to provide a map of available spaces and is capable of guiding motorists to available spaces using guidance means of the global positioning system (GPS) type. Such a system is complex and expensive to implement since it requires new equipment both at the road side and in motor vehicles. Furthermore, it does not solve the problem completely, insofar as a plurality of motorists can thus be guided to the same single space.

The present invention seeks to solve these problems and to do so in a manner that is particularly simple and advantageous.

Many motorists can predict when they are going to need parking space. A non-negligible quantity of motorists are in a position to forecast travel times. Thus, many motorists know in advance that they intend to go to a particular destination and they know the time at which they would like to arrive and the time at which they would like to leave.

The Applicant has thus addressed the problem of providing a system for reserving parking space that enables motorists' mobility to be facilitated and that gives easier access to roadside parking spaces.

By means of such a system, each motorist having a reservation is sure to have a parking space. Whereas those motorists who have not been able to obtain a reservation because all of the parking spaces are saturated find themselves encouraged to leave their vehicles behind when going to town and to seek other means of transport, or else to postpone traveling to a later time within the day or the week.

The present invention thus provides a method of reserving a parking space and apparatus for implementing such a method.

The reservation method relates more particularly to a plurality of pay parking spaces supervised by at least one parking terminal of the parking meter type, i.e. including indicator means for each space it supervises, which indicator means indicate the state of payment defining whether or not parking is authorized.

According to the general definition of the invention, the method comprises the following steps:

a) a user defining a reservation request in accordance with selected parameters;

b) the user receiving in return reservation data and the identity of at least one available parking space corresponding to said selected parameters;

c) at the appropriate time, the user presenting said reservation data to the parking terminal associated with said parking space; and

d) the terminal verifying said data and using said indicator means to indicate corresponding authorization to park.

According to another characteristic of the reservation method of the present invention, the reservation request can be sent directly to a parking terminal.

According to another characteristic of the reservation method of the present invention, the reservation request can be sent to a reservation center.

According to another characteristic of the reservation method of the present invention, the reservation data includes a reservation code (RC) specific to the reservation.

According to another characteristic of the reservation method of the present invention, the reservation data includes an identifier specific to the user.

According to another characteristic of the reservation method of the present invention, the reservation code is determined, taking account of the user identifier and/or of at least some of the parameters defining the reservation request.

According to another characteristic of the reservation method of the present invention, the parameters of the reservation request relate to parking location, date and duration, and also optionally to associated services, mode of payment, and/or reservation fee.

According to another characteristic of the reservation method of the present invention, it further includes a confirmation step in which the user confirms the reservation for a given parking space.

According to another characteristic of the reservation method of the present invention, it further includes a step of locking and unlocking access control means that restrict access to parking sites during reserved periods to only those users who have made reservations.

The invention also provides reservation apparatus for implementing the method of reserving a plurality of pay parking spaces.

According to the invention, the reservation apparatus is characterized in that it comprises at least one parking meter type terminal supervising said parking spaces, said terminal including, for each supervised space, indicator means for indicating the state of payments defining whether or not parking is authorized, and reservation means suitable for receiving a reservation request for a defined parking space in accordance with selected parameters, for generating reservation data, and for identifying at least one available parking space corresponding to said selected parameters, and certification means carried by the terminal associated with said reserved parking space and suitable for verifying the reservation data presented by the user.

According to another characteristic of the reservation apparatus of the present invention, said reservation means are carried by each of said terminals (BO).

According to another characteristic of the reservation apparatus of the present invention, the reservation means are constituted by a reservation server.

According to another characteristic of the reservation apparatus of the present invention, the reservation server co-operates with a communications portal suitable for communicating with the user via at least one communications means belonging to the group comprising: wired or wireless telephony means; data interchange means; fax machines; voice recognition devices; and Internet communications devices or the like.

According to another characteristic of the reservation apparatus of the present invention, the reservation server includes calculation means suitable for calculating all or some of the reservation data.

According to another characteristic of the reservation apparatus of the present invention, the terminal further comprises communications means suitable for communicating with the operator managing the parking terminals and/or with said reservation server to provide information relating to the availability of parking spaces that it supervises.

According to another characteristic of the reservation apparatus of the present invention, the apparatus further comprises remote control access control means suitable for restricting access to parking sites during reservation periods to only those users who have made reservations.

According to another characteristic of the reservation apparatus of the present invention, said access control means can be remotely controlled via a mobile telephone.

The present invention also provides a reservation server suitable for co-operating with said reservation apparatus.

The present invention also provides a parking terminal suitable for co-operating with the reservation apparatus.

The present invention also provides a communications portal suitable for co-operating with the reservation apparatus.

The present invention also provides means for controlling access to a site suitable for co-operating with the reservation apparatus.

Other characteristics and advantages of the invention appear in the light of the following detailed description and the drawing, in which:

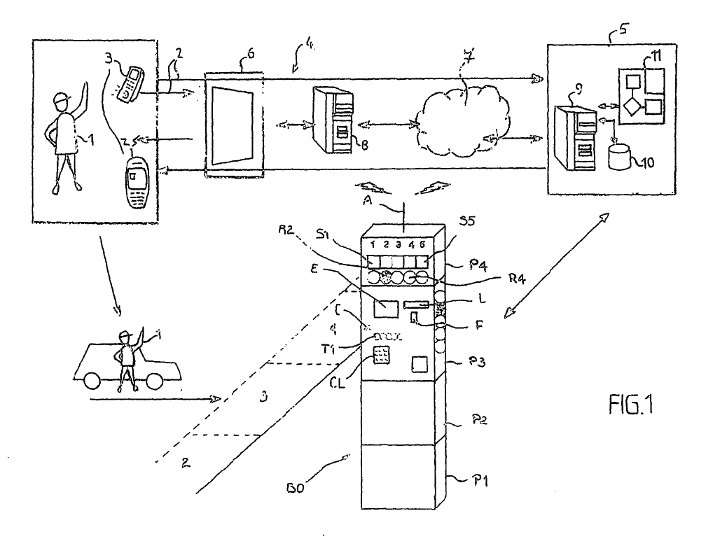

FIG. 1 is a diagrammatic view showing the apparatus and the method of the invention for reserving parking spaces.

The present invention gives a motorist, referenced 1, the option of reserving at least one parking space in advance in a street fitted with parking terminals BO or in a district whose streets are fitted with parking terminals BO.

Each of the terminals BO is in the form of a parking meter supervising one or more parking spaces. In the embodiment shown, the terminal BO supervises five parking spaces numbered 1 to 5.

In conventional manner, these terminals BO are terminals designed specifically for use in public places. They therefore present special features in terms of component parts and software, energy consumption, ease of use, etc., which are well known in themselves and are not described in greater detail herein.

The parking terminal BO shown is generally in the form of a rectangular parallelepiped being about 1.70 meters (m) high, about 50 centimeters (cm) wide, and about 40 cm deep.

The terminal BO preferably comprises four individualized portions referenced P1 to P4.

The portion P1 corresponds to the first level of the terminal relative to the ground, and by way of example it comprises elements that are not directly associated with the invention.

The portion P2 disposed on the portion P1 contains, for example, a strong box (not shown) for containing coins.

The portion P3 has a man/machine interface MMI on its front face, as described below.

The portion P4 has visual indicator means VIM which are also described below in greater detail. These visual indicator means VIM enable wardens in charge of monitoring parking spaces and booking illegally parked vehicles to determine visually the state of payment for parking spaces.

The visual indicator means VIM are disposed in such a manner that wardens in charge of monitoring parking spaces can take cognizance quickly and without difficulty of the indications that appear on the indicator means, e.g. from a vehicle that is traveling on the street.

With reference to FIG. 1, the man/machine interface MMI includes a slot F for inserting coins whose total value determines the desired parking time. The coins inserted through the slot are checked by a coin selector (not shown) which detects the actual value inserted through the slot F. In practice, after passing through the coin selector, coins are stored in a strong box housed in the portion P2.

The terminal BO may be fitted with means for giving change.

On the basis of the value inserted and on the basis of present time information as delivered by a time base (e.g. a clock type circuit), the electronic control circuit (not shown) of the terminal determines the time at which authorized parking expires. This expiry time is displayed by a display screen E. The control circuit comprises in particular a microcontroller, ROM, RAM, and EEPROM type memories, and input/output interfaces.

Instead of or in addition to the coin selection, the terminal BO may be fitted with a payment card reader L disposed above or below the coin selector. The card reader may be adapted to read cards having a magnetic track or cards having an electronic memory, also known as “smart” cards.

The card reader may be accompanied by buttons for selecting data associated with reading payment cards. The buttons may also serve to select the language of the man/machine procedure.

Similarly, the display screen E may be accompanied by selection buttons enabling certain parameters associated with the payment transaction to be selected.

A keypad C is also provided comprising a row of five individual keys referenced T1 to T5 enabling the parking site selected by the user to be identified.

The indications carried on the front face of the portion 3, possibly in association with marking on the ground in the parking spaces, serve to identify clearly and without ambiguity which spaces that correspond to the keys T1 to T5, in order to give the order and the configuration of the parking site relative to the terminal, and thus guide the user in making a selection.

The number of keys in the keypad C may be modified as a function of the configuration of the parking sites.

The keypad C is accessible to the user in order to identify the parking site that has been selected from amongst the plurality of sites supervised by the parking terminal BO.

By way of example, the keys T1 to T5 of the keypad C are of the pushbutton type.

In accordance with the invention, the terminal further comprises means for inputting a reservation secret code described in greater detail below. These means are formed by a keypad CL comprising at least ten keys corresponding respectively to the digits 0 to 9, together with keys corresponding to predetermined functions.

Naturally, the elements of the man/machine interface as described above are not limiting on the invention. The terminal BO may also include a scanner, an infrared communications device, a voice recognition device, or indeed a device for exchanging data, operating using protocols such as IrDA, “Bluetooth”, or the like.

In its portion P4, the terminal BO includes visual indicator means VIM for displaying the monitoring status of the sites supervised by the terminal BO and also the status of any reservation of said sites. These visual indicator means VIM may be disposed on the front face and/or the rear face of the terminal BO, depending on the disposition of the man/machine interface of the terminal relative to the street VO.

It is very advantageous for the visual indicator means to be disposed in such a manner that parking wardens can take cognizance of the payment status of the parking spaces from a vehicle traveling along the street. In other words, the man/machine interface of the terminal may be placed facing the street or it may have its back to the street, while the visual indicator means are preferably placed facing the street. The way in which the man/machine interface is managed naturally takes account of the disposition of the terminal relative to the street. In a variant, the visual indicator means VIM can be visible simultaneously from the front face and from the rear face and possibly also from the side faces.

In the non-limiting embodiment of FIG. 1, the visual indicator means VIM have two sets of visual indicator elements associated with the parking sites supervised by the terminal BO. Naturally that is merely one possible embodiment and it could very well have only one set of visual indicator elements associated with the sites supervised by the terminal and serving to perform the same functions as the two sets shown.

The visual indicator elements are arranged in a manner that corresponds to the arrangement of the parking sites relative to the terminal so as to indicate the order and the configuration of the parking sites relative to the terminal, thereby assisting parking wardens.

The first set of visual indicator elements S1 to S5 indicate the status of each of the spaces: “paid”, “not paid”, “not used”. The “not used” indication corresponds to the terminal BO being used to supervise a number of parking spaces that is smaller than the capacity of the terminal, for example a terminal designed to supervise ten spaces and being used for only seven sites.

The electronic processor unit of the terminal BO compares the parking time limit associated with a site identified by the user using a key Ti of the keypad C with time information delivered by the time base of the above-mentioned electronic circuit, and it processes the result of the comparison in order to display it in real time on the corresponding visual indicator element Si.

For example, the individual indicator elements S1 to S5 for indicating the monitoring status of the associated parking sites are display elements that change state or that emit light, each possessing three horizontal display strips.

For example, each horizontal strip may be in an active light-emitting or yellow color state when switched on or in a non-active or black color state when switched off. It is then possible to define the “paid”, “not paid”, and “not used” states as follows:

a “not used” state in which all three horizontal strips are black in color, indicating that the corresponding site is not supervised or monitored by said terminal;

a “not paid” state in which the central horizontal strip is yellow in color, while the two horizontal strips on either side of it are black in color, indicating that the corresponding site is supervised or monitored by said terminal, but that no payment has been made for said space and that consequently any vehicle occupying the corresponding site is parked illegally; and

a “paid” state in which all three horizontal strips are yellow in color, indicating that the corresponding site is supervised or monitored by said terminal, and that the space has been paid for and consequently any vehicle occupying the corresponding site is parked legally.

A second set of visual indicator elements R1 to R5 indicates the reservation status of the spaces: “reserved” or “not reserved”. These elements may be in the form of light-emitting diodes (LEDs), for example, which when switched on indicate that the space has been reserved and when switched off indicate that the space is not reserved.

The terminal BO also has an antenna A disposed on top of the portion P4 and which co-operates with radiofrequency communications transceiver means (not shown) enabling the terminal to communicate with the outside.

The terminal BO is thus adapted to communicate with a parking management server PMS dedicated to operating and managing the network formed by the terminals BO.

The function of the management server is to exchange information with all of the terminals BO concerning their operation.

Naturally, data transfer between the terminals BO and the remote management server can make use of other communications networks, and in particular wired networks whether priority or otherwise, and in particular the public switched telephone network PSTN.

When the terminals BO do not have any telecommunications means, such transfers can also be implemented manually by an operator doing a round of the terminals. This operator has a hand-held appliance suitable for downloading the data supplied by the parking terminal for subsequent transfer to the management server, and also for delivering data from the management server to the parking terminals.

The terminal BO may also be required to communicate directly with a reservation server as described in detail below, or indeed directly with users, either to make a reservation as also described below, or else to operate payment mobile, i.e. payment via a telephone terminal of the GSM type (global system for mobile communications).

The terminal BO may have its own power supply in the form of a solar panel adapted to provide the energy it needs.

With the terminal BO described in detail above, the remainder of the system needed for reserving a parking space supervised by such a terminal is described below in turn.

The motorist 1, preferably before embarking in the vehicle, defines a request 2 to reserve a parking space by using an interrogation device 3, which is of the multimedia type, for example, such as a personal computer connected to the Internet or such as a mobile telephone, for example.

The request 2 takes account of the needs of the user 1, for example: where does the user want to go?, when does the user want to arrive?, how long does the user want to stay?, when does the user want to leave?, what payment means does the user desire to use? The request may also be more precise, specifying directly the parking space that the user 1 desires to occupy.

The call 4 (or information interchange) between the interrogation device 3 of the user 1 and a server 5 of a reservation center can be implemented in various ways.

For example, the call 4 may require both the user and the reservation server 5 to possess multimedia access means which process data, voice, faxes, e-mail, or the like.

The calls preferably make use of the Internet 7, preferably using an access portal 6 interposed between the user and the reservation server 5. In practice, these means are capable of converting the request from the user 1 into a format that is suitable for exchanging information with the reservation server 5.

The portal 6 may be fitted with processing and storage means 8 in order to store information about users and to profile them.

The reservation server 5 has processor means 9 suitable for receiving the reservation request, processing it, and storing it in a memory 10.

The reservation server 5 is capable of searching on behalf of the user to find the best available parking space satisfying the parameters defined by the user on the basis of the information that has been collected from the various terminals BO which provide information directly or via the remote management server PMS of the parking terminal operator, which server, as mentioned above, centralizes information coming from the various terminals in real time or in deferred time using suitable data transfer means, and in particular information comprising the “paid” or “not paid” status of the parking spaces under their control.

The reservation server 5 thus responds to the request from the user 1, via the portal 6 where appropriate, with one or more proposals for spaces that are suitable for being reserved and that correspond as closely as possible to the user's request.

Where appropriate, the user 1 confirms the proposal that corresponds best to the user's expectations.

The reservation request 2 may be accompanied by a user identifier ID. This identifier ID may be the name of the user, the number of a payment card, a mobile telephone number, the number of the SIM card of the mobile telephone, etc.

The reservation process thus terminates by the reservation server 5 sending the user 1 references (location, . . . ) for the terminal BO and the site number together optionally with a reservation code RC, particularly when the user 1 does not have an identifier.

The reservation code RC, when one exists, is calculated, for example, using appropriate calculation means 11 taking account of the user identifier and/or of at least some of the parameters of the reservation request, in particular information relating to the site, the date, and the duration or to services associated with the reservation.

In a variant, a unique reservation code RC may be allocated in permanent manner to a given user, for example a subscriber to the reservation center.

The calculation means 11 may include cryptography means used in conventional manner for securing data.

The reservation data, and thus the code RC, is thus communicated to the user 1 and stored in various ways, for example written down on a piece of paper or in an appliance suitable for storing such data, such as, for example, a mobile telephone, a memory card, a personal digital assistant, etc. The code may be input manually (e.g. by using a manual keypad) or automatically (using a magnetic track, a bar code, or the like) in order to be communicated to the corresponding terminal BO.

In parallel with the above-mentioned information being sent to the user 1, the reservation server 5 sends the corresponding information to the terminal BO, either directly or via the management server.

The terminal BO stores in its electronic circuits the fact that a space, e.g. space No. 1, has been reserved for a given time period, e.g. 12 noon to 1:00 PM, at a given date, e.g. Tuesday May 29, 2001.

On that day, in the time range 12 noon-1:00 PM, site No. 1 is no longer accessible except for the user 1 who has reserved it. Thus, if the space is empty and a car parks in it at 10:30 AM, the motorist will not be able to obtain parking of duration in excess of 1 hour (h) 30 minutes (min).

An indication about the space being reserved from 12 noon is communicated by the terminal BO to the motorist when that space is selected or during payment or when the maximum available time is reached or on approaching said maximum time of predetermined duration. The motorist then knows that the space must be vacated at 12 noon.

At 12 noon, the indicator light R1 lights up indicating that space No. 1 has been reserved. Nobody other than the person who has reserved it can then pay for this site and its signal Si remains in the “not paid” state and R1 remains in the “reserved” state.

When user 1 arrives at the specified time in the street where the space has been reserved, the user parks in the reserved site No. 1 which should normally be empty and goes to the corresponding terminal BO.

The user can then identify his- or herself to the terminal BO by using the above-described man/machine interface MMI and by inputting the reservation code RC, if there is one, or by inputting the user identifier ID.

The terminal BO then verifies the information supplied by the user in comparison with the information received from the reservation server. In particular, the terminal can verify the reservation code RC or the identifier ID as presented, the mode of payment and its validity, or other parameters relating to the user request or to the special status of the user.

Once the reservation information has been verified, the terminal BO unlocks access to the site No. 1, and insofar as the space was not prepaid at the time of making the reservation, it becomes possible for the user to pay for the reserved period. The user 1 can obtain a longer parking duration if no reservation has been made for the period 1:00 PM to 2:00 PM. Once site No. 1 has been paid for, the terminal BO causes the signal S1 to switch from the “not paid” state to the “paid” state.

According to the invention, the reservation method enables transactions to be made quickly, it enables access rights to be calculated securely at the reservation server 5 and also locally at the terminal BO, and it enables various communications means to be used that are independent of the technology that is employed.

Naturally, the present invention is not limited to the particular element described.

Thus, the visual indicator means VIM provided in the portion 4 of the terminal are not necessary for implementing the present invention. Indicating the states of payments and thus the authorized or not authorized status of each of the sites under the control of the terminal BO can be communicated to parking wardens in other ways: such as a paper ticket printed by the terminal or data transmitted to a hand-held appliance carried by the parking wardens.

The present invention thus also covers the possibility of making a reservation not from a central site but also directly with the parking terminal BO.

Making a reservation directly with the terminal BO can take various forms: it can be done directly using the above-described man/machine interface MMI, or from a radio terminal suitable for dialoguing with said terminal, or indeed from any multimedia terminal capable of dialoguing with said terminal, or even from another parking terminal.

Consider the case of making a reservation via the man/machine interface MMI. The user indicates that the or she would like to make a reservation by means of a suitable function key and then selects the site(s) for reservation and then inputs the date and the times concerned, and finally the user's own ID if such an identification key is available.

As an alternative to the description above, the identifier may also be a code if the user is a subscriber to a centralized service or to payment means such as a credit card. If the user does not have such an identifier, then the terminal generates a secret key which is used as an identifier and which is given to the user. In this case the identifier acts as the reservation code RC.

In order to be complete, the reservation operation may require prepayment for the space reserved in this way and the amount paid may optionally incorporate a flat rate reservation fee.

Where appropriate, and in conventional manner, the terminal BO can have printer means 10, e.g. of the thermal head type, suitable for issuing a ticket 12. The ticket can then act as a receipt summarizing information about the reservation. In particular, if the terminal BO has issued an identifier, then the ticket will indicate the identifier.

It is assumed that space No. 3 has been reserved for the period 10:00 AM to 11:00 AM. If a user who has not made a reservation arrives at 9:15 AM, that user will be able to pay only for the remaining 45 minutes in respect of space No. 3. The indication that the space has been reserved from 10:00 AM is communicated to the user by the terminal BO.

At 10:00 AM, the indicator light R3 turns on, indicating that the space has been reserved. Thereafter no one other than the person who made the reservation can pay for this site, and the signal S3 therefore remains in the “not paid” state. The user who has made the reservation needs to input the user's own ID or the ID issued by the terminal BO. Inputting this code releases the terminal with respect to site No. 3. Thus, insofar as the space has not been paid for, the terminal allows payment to be made for the period in question (and beyond if no reservation has been made for the period 11:00 AM to 12 noon), and insofar as the space has already been paid for causes the signal S3 to switch to its paid state.

The presence of an illegally parked vehicle in a site that has been reserved can lead to parking wardens to apply for the vehicle to be taken immediately to the car pound and/or for the price paid for the space to be reimbursed to the person who made the reservation and who cannot use that site because of the illegally parked vehicle.

Optionally, the terminal BO may be provided with means for detecting the presence of a vehicle in the spaces under its supervision, thereby making it possible to generate a warning if a reserved space is occupied without the driver having input an identifier.

The reservation system of the invention thus enables parking and traffic to be improved in a city. Motorists who have not been able to reserve a space because the parking spaces are saturated are dissuaded by the system from driving into town.

In addition, the ability to reserve a site is a significant tool in encouraging turnover of parked vehicles and in preventing a single user from monopolizing a space beyond the maximum time allowed, where it is difficult for parking wardens to check this maximum allowed time.

In a variant embodiment, it is also possible to provide parking sites with remotely controlled access control means such as retractable bollards, these access control means serving to block access to such sites during reserved periods. Only users who have made a reservation can then cause these access control means to be operated to allow their vehicles to park. This can be controlled from the man/machine interface MMI of the corresponding terminal or by using a mobile telephone of GSM or other type, suitable for dialoguing with said terminal BO, or directly with said access control means, or indeed with the reservation server 5.

1. A method of reserving a plurality of pay parking spaces supervised by at least one terminal (BO) of the parking meter type, including indicator means for each supervised space for indicating the state of payment (Si) defining whether or not parking is authorized, the method being characterized in that it comprises the following steps:
a) a user defining a reservation request in accordance with selected parameters;
b) the user receiving in return reservation data and the identity of at least one available parking space corresponding to said selected parameters;
c) at the appropriate time, the user presenting said reservation data to the parking terminal (BO) associated with said parking space; and
d) the terminal (BO) verifying said data and using said indicator means to indicate corresponding authorization to park.

2. A method according to claim 1, wherein the reservation request can be sent directly to a parking terminal.

3. A method according to claim 1, wherein the reservation request can be sent to a reservation center.

4. A method according to claim 1, wherein the reservation data includes a reservation code (RC) specific to the reservation.

5. A method according to claim 1, wherein the reservation data includes an identifier (ID) specific to the user.

6. A method according to claim 4, wherein the reservation code (RC) is determined, taking account of the user identifier (ID) and/or of at least some of the parameters defining the reservation request.

7. A method according to claim 1, wherein said parameters of the reservation request relate to parking location, date and duration, and also optionally to associated services, mode of payment, and/or reservation fee.

8. A method according claim 1, wherein said method further includes a confirmation step in which the user confirms the reservation for a given parking space.

9. A method according to claim 1, wherein said method further includes a step of locking and unlocking access control means that restrict access to parking sites during reserved periods to only those users who have made reservations.

10. Apparatus for reserving a plurality of pay parking spaces, said apparatus comprising:
at least one parking meter type terminal (BO) supervising said parking spaces, said terminal (BO) including, for each supervised space, indicator means for indicating the state of payments (Si) defining whether or not parking is authorized, and reservation means suitable for receiving a reservation request for a defined parking space in accordance with selected parameters, for generating reservation data, and for identifying at least one available parking space corresponding to said selected parameters, and certification means carried by the terminal (BO) associated with said reserved parking space and suitable for verifying the reservation data presented by the user.

11. Apparatus according to claim 10, wherein said reservation means are carried by each of said terminals (BO).

12. Apparatus according to claim 10, wherein said reservation means are constituted by a reservation server.

13. Apparatus according to claim 12, wherein said reservation server co-operates with a communications portal suitable for communicating with the user via at least one communications means belonging to the group comprising: wired or wireless telephony means; data interchange means; fax machines; voice recognition devices; and Internet communications devices or the like.

14. Apparatus according to claim 12, wherein said reservation server includes calculation means suitable for calculating all or some of the reservation data (RC).

15. Apparatus according to claim 12, wherein said terminal (BO) further comprises communications means suitable for communicating with the operator managing the parking terminals and/or with said reservation server to provide information relating to the availability of parking spaces that it supervises.

16. Apparatus according to claim 10, wherein said apparatus further comprises remote control access control means suitable for restricting access to parking sites during reservation periods to only those users who have made reservations.

17. Apparatus according to claim 16, wherein said access control means can be remotely controlled via a mobile telephone.

18. A reservation server suitable for co-operating with the reservation apparatus according to claim 12.

19. A parking terminal suitable for co-operating with the reservation apparatus according to claim 10.

20. A communications portal suitable for co-operating with the reservation apparatus according to claim 13.

21. A means for controlling access to a site and suitable for co-operating with the reservation apparatus according to claim 16.
